(19) United States
(12) Patent Application Publication
(10) Pub. No.: US 2025/0125521 A1
(43) Pub. Date: Apr. 17, 2025

(54) DECORATIVE RADOME WITH TRANSPARENT VISUAL FEATURE

(71) Applicant: MOTHERSON INNOVATIONS COMPANY LIMITED, London (GB)

(72) Inventors: Scott EDWARDS, Lonsdale (AU); Simon David FIELD, Lonsdale (AU); Bill FRANK, Lonsdale (AU); Bastian STOEHR, Lonsdale (AU)

(21) Appl. No.: 18/687,078

(22) PCT Filed: Aug. 29, 2022
(86) PCT No.: PCT/EP2022/073978

§ 371 Date: Feb. 27, 2024

(30) Foreign Application Priority Data
Aug. 30, 2021 (DE) 10 2021 122 399.7

(51) Int. Cl. H01Q 1/42

(52) U.S. Cl. CPC H01Q 1/42

(57) ABSTRACT

The inventions relates to radome having a first side and a second side, the radome comprising: a radio-transmissive and visually-transparent substrate which has on at least the first or second side a hard coat layer to provide a hard-coated surface; a radio-transmissive layer comprising a metal and/or metal alloy applied to the hard-coated surface; and a primary visually-opaque layer, wherein a portion of the radome is void of the primary visually-opaque layer, an assembly comprising such a radome, a vehicle comprising such a radome and/or such an assembly as well as a method of producing such a radome.

### CROSS-REFERENCE TO RELATED APPLICATIONS

This application is a National Stage Entry of International Patent Application No. PCT/EP2022/073978, filed on Aug. 29, 2022, which claims priority to German Patent Application No. DE 10 2021 122 399.7, filed on Aug. 30, 2021, both of which are incorporated by reference herein for all purposes.

### TECHNICAL FIELD

The invention relates to radomes having various visual features including a coating comprising multiple layers provided on a substrate. Particularly the radomes are useful for automotive and vehicular purposes and therefore the surface coating and/or the layers need(s) to meet the strict wear and resilience requirements needed for external automotive components as well as being sufficiently radio-transmissive to permit minimally attenuated transmission of radio-wave frequencies used in Radio Detection and Ranging (RADAR) systems.

### BACKGROUND OF INVENTION

Since their development in the early 20th century, Radio Detection and Ranging (RADAR) systems have evolved and have been miniaturised such that they are now integrated into a range of everyday devices. One common use of radar is in driver assistance systems in vehicles. Radar is used for a variety of warning systems, semi-autonomous systems and autonomous systems in vehicles. Such systems include proximity detection, which can be used for parking assistance, adaptive cruise control, crash avoidance and blind spot detection. Further, radar, in combination with light illuminating detection and ranging (LIDAR) systems, provide the sensing systems being developed for autonomous, and semi-autonomous, vehicles.

Radar systems work on the basis that illuminating radio-waves (radar signals), emitted from a transmitter, are reflected or scattered by solid objects. These reflected radar waves are then detected by a receiver, which is generally proximal to the transmitter, allowing the radar system to detect an object. Typically, radio-waves are reflected when travelling between mediums having different electric conductivity. As such, radar systems are particularly effective at detecting electrically conductive materials, such as metals. However, this presents a problem when trying to develop radar compatible materials which have a metallic appearance.

As it is not desirable to externally view the radar system, and as the radar system need to be protected from environmental damage, radar systems are typically located behind a radome. A radome is a protective cover which is substantially radio-wave transparent, and therefore does not substantially attenuate radio signals. Suitable materials for providing a radome include synthetic polymers (such as plastics) which are electrically insulating. However, integration of such plastic radomes, when a metallic finish is desired, has been difficult to achieve. Typical metallic finishes, such a chromium films on plastic, reflect radio signals and therefore are not suitable for use in radomes.

Techniques and systems have been developed to provide plastic radomes with a metallic appearance. However, most of these techniques and systems require complex layering of substrates with sandwiched layers of metallic appearance. Further, the specific positioning and alignment of these multiple layers is challenging making it difficult to integrate fine visual features.

To improve the visual appearance of radomes with a metallic appearance, it may be desirable to provide visual features which can be backlit, for example symbols or outlines. This can be challenging. Current techniques for deposition of metallic layers typically do not provide a sharp edge and therefore complex masking may be necessary. Further, thin metallic films are normally partially transparent and allow significant light bleed-through.

Therefore, there is a need to provide a radome with portions having a metallic appearance and portion which can be selectively backlit without significant light bleeding through the metallic portions.

The above discussion of background is included to explain the context of the present invention. It is not to be taken as an admission that any of the material referred to was published, known or part of the common general knowledge at the priority date of any one of the claims.

### SUMMARY OF INVENTION

The present invention aims to provide a radome which can achieved a desired visual appearance. In particular, it is desirable to have a radome with at least a portion having a metallic appearance, and which also includes a portion that permits light to traverse the radome thereby permitting for an illuminated visual feature in the radome when a light source is provided, preferably from the rear side of the radome.

Typically, radio-transmissible metal or metal alloy layers are thin-film coatings which are substantially transparent to light. As such, rear illumination of these films will lead to significant light bleed-through, which will result in a poor aesthetic. To overcome this, the present inventors have devised a multi-layered solution which includes a primary visually-opaque layer and/or visually-opaque coating that prevents the transmission of light through the metal, or metal alloy, layer.

Accordingly, provided herein is a radome, having a first side and a second side, the radome comprising: a radio-transmissive and visually-transparent substrate which has on at least the first or second side a hard coat layer to provide a hard-coated surface; a radio-transmissive layer comprising a metal and/or metal alloy applied to the hard-coated surface; and a primary visually-opaque layer, wherein a portion of the radome is void of the primary visually-opaque layer.

The primary visually-opaque layer acts to prevent light transmission across the radome (with the exclusion of the void portion), while the layer comprising a metal and/or metal alloy provides a portion with a metallic and/or reflective appearance. The void provides a path for light transmission through the radome, thereby allowing selective illumination. Accordingly, providing a light from the rear will provide an illuminated visual feature.

The side of the substrate that has the above layers applied will determine if the radome is a first surface radome, or a second surface radome. Accordingly, in some embodiments, the primary visually-opaque layer is located on the first side of the radome. In some embodiments, the primary visually-opaque layer is located on the second side of the radome.

In some specific embodiments there is provided a radome, having a first side and a second side, the radome comprising: a radio-transmissive substrate which has on at least a first side a primary visually-opaque layer; a hard-coat layer covering at least a portion of the primary visually opaque layer to provide a hard-coated surface; and a radio-transmissive layer comprising a metal and/or metal alloy applied to the hard-coated surface, wherein a portion of the radome is void of the primary visually-opaque layer.

In another specific embodiment there is provided a radome, having a first side and a second side, comprising: a radio-transmissive substrate which has on a second side a hard coat layer to provide a hard-coated surface; a radio-transmissive layer comprising a metal and/or metal alloy applied to the hard-coated surface; and a primary-visually-opaque layer located on the second side of the layer comprising a metal and/or metal alloy, wherein a portion of the radome is void of the primary visually-opaque layer.

The void portion does not contain the primary visually-opaque layer. However, and given that thin metallic coating, may be transparent, it is possible that the void portion is overlaid with the layer comprising the metal and/or the metal alloy. However, in some preferred embodiments, the portion void of the visually-opaque layer is also void of the layer comprising a metal and/or or metal alloy.

In some preferred embodiments, the radio-transmissive substrate is a polymer and in particular a plastic. Polymers, such as plastics, provide the required properties of being radio-transmissive and visually-transparent. They also provide appropriate design freedom as they can be shaped, formed and moulded. Further, some plastics have considerable robustness which makes them suitable for high-impact uses such as in vehicles and automobiles. One preferred polymer is polycarbonate.

As discussed, it is desirable to provide a radome with particular visual features; which may include visual features in addition to the reflective/metallic portions and the void portion. To facilitate this, some embodiments of the radome comprise a decorative layer. This decorative layer, can be used to add additional visual features, such as colour.

In some embodiments, the decorative layer is a secondary visually-opaque layer. In this form, the decorative layer is both viewable and prevents light-transmission across the radome.

These visual features will be provided such that they can be viewed from the viewing side (first side) of the radome. In the case of a second surface radome the decorative layer can be viewed through the substrate. In such an embodiment, the decorative layer may be provided directly to the substrate. This is opposed to other embodiments, such as a first surface radome wherein the primary visually-opaque layer may be located directly on the substrate.

Methods are known in the art for providing suitable visually-opaque layers and decorative layers. In some embodiments, the primary visually opaque layer or the decorative layer is an ink, dye, oil, wax, lubricant or a film.

In embodiments of the radome which include both a primary visually-opaque layer and a decorative layer the primary visually-opaque layer and the decorative layer are interspaced by the layer comprising a metal and/or a metal alloy.

In some embodiments, the decorative layer overlaps with at least a portion of the layer comprising a metal and/or metal alloy thereby obstructing the view of the layer comprising a metal and/or metal alloy. This can assist in defining the visual characteristics (such as the boundary) of the underlying layer (i.e. the layer comprising a metal or metal alloy).

Preferably, the primary-visually opaque layer is provided to areas where it is not desirable for light to traverse the radome. These areas often correspond with areas where the layer comprising a metal and/or metal alloy is also deposited (to prevent light bleeding through this layer). Therefore, in some embodiments, the primary visually-opaque layer overlaps with at least a portion of the layer comprising a metal and/or metal alloy. Preferably, when viewed from a viewing side of the radome, the visually-opaque layer underlies the layer comprising a metal and/or metal alloy.

The layer comprising a metal and/or metal alloy may comprise any suitable metal or metal alloy. In preferred embodiments, the layer comprising a metal and/or metal alloy comprises indium. In some embodiments, the layer comprising a metal and/or metal alloy is a stacked-layer comprising multiple layers. In some embodiments, this includes a layer of silicon dioxide. Accordingly, in some embodiments, the layer comprising a metal and/or metal alloy includes a layer of indium and a layer of silicon dioxide.

To improve the robustness of the substrate it may be desirable for the radome to have a hard coat layer on the exposed side of the substrate (i.e. the side of the substrate that does not contain the above-described layers). Therefore, in some embodiments, the substrate has a hard coat layer on both the first and second surfaces.

The hard coat layer may be any suitable hard coat; however, is some embodiments, the hard coat is selected from one or more of: an organo-silicon, an acrylic, a urethane, melamine or an amorphous SiOxCyHz.

In some embodiments, the radome comprises a final hard coat layer covering underlying layers. This final hard coat layer may act as a rear hard coat layer or as a front hard coat layer and acts to protect the underlying layers. In some embodiments, there is an adhesion-promoting layer, which promotes adhesion between a final hard coat, in particular a hard coat layer to provide a hard-coated surface, a front hard coat layer and/or a rear hard coat layer, with an underlying layer.

The radome of the present invention is intended to be used with radar systems and with back-lighting. Therefore, the present invention also provides an assembly comprising the radome as described and a radio-wave transmitter and/or receiver. Further, in some embodiments, the assembly comprises a light and/or light source for illuminating, in particular for illuminating the void portion of the radome.

The radome and assembly of the present invention have been particularly developed for use in vehicles. Therefore, there is provided a vehicle comprising a radome or assembly as described.

The present invention also provides a method of producing a radome, comprising the steps of: providing a radio-transmissive substrate; applying a hard coat layer to at least a first or second surface to provide a hard-coated surface; applying a radio-transmissive layer comprising a metal and/or metal alloy to the hard-coated surface; applying a primary visually-opaque layer; and providing a portion of the radome which is void of the primary visually-opaque layer.

Importantly, the timing of the deposition of the layers, particularly the primary visually-opaque layer, will vary depending on if the radome is a first or second surface radome. This variation will be become apparent as further embodiments of the invention are described and exemplified.

The void portion may be provided by not applying the primary visually-opaque layer, and, optionally, the layer comprising the metal and/or metal alloy to the desired portion. In some preferred embodiments, the portion of the radome which is void of the primary visually-opaque layer, and, optionally, the layer comprising a metal and/or metal alloy, is formed by laser etching. In such an embodiment, the substrate can have the relevant layers applied across its surface, and then the void portion formed by laser etching away the applied layers. This is advantageous as it does not require masking or alignment of the respective layers to accurately form the void portion. This allows for details that would be otherwise difficult to achieve.

In some embodiments of the method, the primary visually-opaque layer is applied before the application of the hard coat layer. In some specific embodiments, the primary visually-opaque layer may be provided on the substrate. This is particularly envisaged when the radome is a first surface radome and the primary visually-opaque layer is provided on the first side of the radome. In some embodiments, the primary visually-opaque layer is applied after the layer comprising a metal or metal alloy. This is particularly envisaged when the radome is a second surface radome, although it may also be used in other countries.

Suitable substrates for use in the method of the present invention have been described above and include, polymers, plastics and polycarbonate.

To achieve the desired shape of the radome, in some embodiments, providing the radio-transmissive substrate comprises moulding the substrate. Suitable moulding techniques include thermo-moulding, injection moulding or injection compression moulding. In some embodiments of the method, the substrate is provided already moulded.

The preferred technique for applying the layer comprising a metal and/or metal alloy is physical vapor deposition (PVD); however, any suitable technique is included in the method of the invention.

According to the invention, the layer comprising a metal and/or metal alloy is deposited to provide a continuous layer of metal and/or metal alloy. The layer is applied continuously independent from the application technique used.

Suitable metals and metalloid for providing the layer comprising a metal and/or a metal alloy are discussed herein and include indium, tin, aluminium, germanium and silicon.

In some embodiments, the layer comprising a metal and/or metal alloy comprises a stack of multiple layers. In some embodiments, the multiple layers comprise at least a layer of indium and a layer of silicon dioxide.

In some embodiments of the method of the present invention, the layer comprising a metal and/or metal alloy and the visually-opaque layer are applied such that at least portions of the two layers overlap. Such application prevents light bleeding through the layer comprising the metal and/or metal alloy in the portions that overlap.

Embodiments of the present method include the additional step of applying a decorative layer. The function of this decorative layer may be simply to provide visual features to the radome. However, in some embodiments the decorative layer may also contribute to preventing light transmission across the radome. In such embodiments, the decorative layer comprises, in particular is, a secondary visually-opaque layer.

Depending on whether the radome is a first or second surface radome will determine the order of deposition of the layers and which layers are applied to the substrate. In some embodiments, the primary visually-opaque layer is applied directly to the substrate. In other embodiments, the decorative layer is applied directly to the substrate.

In some embodiments of the methods, the primary visually opaque layer or the decorative layer is applied by pad printing. However, other suitable techniques are envisaged.

To provide a hard coat layer (upon which the layer comprising a metal and/or a metal alloy is deposited), in some embodiments of the method, both the layer applied directly to the substrate and the substrate are coated with a hard-coat layer to provide a hard-coated surface and/or are provided with a hard-coat to provide a hard coat layer.

After the application of the various layers, it may be advantageous to apply a final hard coat layer that overlays and protects the underlying layers, in particular the layers on the substrate. Therefore, the method of the invention further comprises the step of applying a final hard coat layer, especially a hard coat layer to provide a hard-coated surface, a front hard coat layer and/or a rear hard coat layer. To promote the adhesion of the final hard coat, in particular between the final hard coat and an underlying layer, the method may include the application of an adhesion-promoting layer. This layer-which is applied after the primary visually-opaque layer, the layer comprising the metal and/or metal alloy and the optional decorative layer-directly underlies the final hard coat layer. An example of such an adhesion-promoting layer is a silicon dioxide layer.

### BRIEF DESCRIPTION OF DRAWINGS

Certain embodiments are illustrated by the following figures. It is to be understood that the following description is for the purpose of describing particular embodiments of the invention only and is not intended to limit the invention to the particularly described embodiments.

FIG. 1 is a cross-section of a second surface radome having a metallic appearance and including a primary visually-opaque layer and a layer comprising a metal and/or metal alloy.

FIG. 2 is a cross-section of a first surface radome having a metallic appearance and including a primary visually-opaque layer and a layer comprising a metal and/or metal alloy.

FIG. 3 is a cross-section of a second surface radome having both metallic and not metallic portion visible from the viewing side. The radome includes a primary visually-opaque layer, a layer comprising a metal and/or metal alloy and a decorative layer.

FIG. 4 is a cross-section of a second surface radome having both metallic and not metallic portion visible from the viewing side. The radome includes a primary visually-opaque layer, a layer comprising a metal and/or metal alloy and a secondary visually-opaque layer.

FIG. 5 is a cross-section of a first surface radome having both metallic and not metallic portion visible from the viewing side. The radome includes a primary visually-opaque layer, a layer comprising a metal and/or metal alloy and a decorative layer.

FIG. 6 is a cross-section of a first surface radome having both metallic and not metallic portion visible from the viewing side. The radome includes a primary visually-opaque layer, a layer comprising a metal and/or metal alloy and a secondary visually-opaque layer.

FIG. 7 is a cross-section of a second surface radome having both metallic and not metallic portion visible from the viewing side. In this embodiment, the layer comprising a metal and/or metal alloy is substantially opaque. The radome includes a primary visually-opaque layer comprising a metal and/or metal alloy and a decorative layer.

FIG. 8 is a cross-section of a first surface radome having both metallic and not metallic portion visible from the viewing side. In this embodiment, the layer comprising a metal and/or metal alloy is substantially opaque. The radome includes a primary visually-opaque layer comprising a metal and/or metal alloy and a decorative layer.

FIG. 9A illustrates a front view of a radome consistent with that illustrated in FIGS. 1 and 2.

FIG. 9B illustrates a front view of a radome consistent with that illustrated in FIGS. 3 to 8.

FIG. 10 illustrates a flow diagram of a method for producing a radome in accordance with the invention, wherein the layer comprising the metal and/or metal alloy is not substantially opaque.

FIG. 11 illustrates a flow diagram of a method for producing a radome in accordance with the invention, wherein the layer comprising the metal and/or metal alloy is substantially opaque.

FIG. 12 illustrates the measured change in attenuation of 77 GHz radio-waves through uncoated polycarbonate as a result of changes in polycarbonate thickness.

FIG. 13 illustrates average attenuation of radio-waves of 76-77 GHz and 79-81 GHz across polycarbonate of 2 mm (A) and 2.3 mm (B) thickness.

### DETAILED DESCRIPTION

Throughout the specification reference will be made to layers and/or coatings in relation to the plastic substrate, the radome and in relation to each other. Therefore, in order to define the spatial relationship of the layers and/or coatings, the following terminology will be used.

“First side” is to be understood as the side of the substrate, coating, or specific layer which in-use faces away from a radio-wave transmitting or receiving device. As such, the first side is the side which is facing toward the external environment. In the specific context of a vehicle, this would be the visible outside of the vehicle.

“Second side” is to be understood as the opposing side to the first side. In an in-use context this is the side facing toward the radio-wave transmitting device, or receiving device. Typically, the second side is not visible when the radome is used.

“First surface” is to be understood to refer to the surface on the first side of a substrate, coating, or specified layer.

“Second surface” is to be understood to refer to the surface on the second side of a substrate, coating, or specified layer.

Further reference may be made to a “viewing side” and “rear side”. Such terms are references to the in use (or intended in use) orientation of the radome. Accordingly, the “viewing side” is the side intended for viewing when the radome is provided in an assemble (such as a vehicle) while the “rear side” opposes the viewing side and is not intended for viewing. For clarity, a radome having layers contained on, or applied to, the first surface will have the layers and/or coatings located on the viewing side of the radome. Alternatively, a radome having layers and/or coatings contained on, or applied to, the second surface will have the layers and/or coatings located on the rear side of the radome.

The term “visually-opaque” refers to substantially inhibiting or preventing the transmission of visible light, typically in the nanometre wavelength and frequency range of 400 to 800 THz. This term should not be interpreted as preventing the transmission of all light. In some embodiments, 60%, 70%, 80%, 90%, 95% or 99% of visible light is prevented from being transmitted.

The term “reflective” (without qualification such as “radio-wave”) refers to reflection of visible light, typically in the nanometre wavelength and frequency range of 400 to 800 THz.

A reference to radio-wave throughout the specification, typically refers to frequencies of 10 MHz to 3000 GHz. In preferred embodiments, and in relation to automotive vehicles, the frequency is typically 1000 MHz to 100 GHz. In some specific embodiments in relation to radomes for vehicles, the frequency is 21 GHz to 81 GHz, or about 24 GHz to about 79 GHz or about 77 GHz to about 79 GHz, or about 24 GHZ, about 77 GHz or about 79 GHz. Use of about in this context does not exclude explicit limitation to a specified band (e.g. 24 GHz) but does envisage the typical band spread used in the applications such as automotive radar systems. These band widths are known in the art for example see Hasch et al. “Millimeter-Wave Technology for Automotive Radar Sensors in the 77 GHz Frequency Band”, IEEE Transactions on Microwave Theory and Techniques (Volume: 60, Issue: 3, March 2012).

Terms such as “transparent”, “reflective” and “opaque” when used without a qualifier (such as “radio-wave” or “radar”) should be interpreted as referring to visual light (e.g. visually-transparent or -opaque), and hence is a reference to transmission, reflection, absorption or prevention of transmission of visible light, as defined above.

Radar systems in vehicles typically use microwaves to provide line-of-sight detection of objects. The three frequencies currently being used are 24 GHZ, 77 GHz and 79 GHz. Primarily, 77 GHz and 79 GHz are used in vehicles as they offer improved range and resolution compared to the 24 GHz frequency. Attenuation of radio-waves increases as the frequency increases, and therefore the microwaves used in automotive radar systems are, by design, susceptible to attenuation. This, however, provides a problem for radomes, and requires them to provide a uniform surface with minimal attenuation of the transmitted and received radio signals. Essentially, a radome needs to be substantially transparent to microwave electromagnetic radiation, and also provides minimal refraction, while ideally containing specific and desirable visual features.

The present invention aims to provide a radome which includes a decorative radio-transmissible metal and/or metal alloy layer, which provides a metallic visual feature, and which also includes a portion which permits light to traverse the radome, thereby permitting an illuminated visual feature in the radome when a light source is provided, preferably from the rear side of the radome.

Typically, radio-transmissible metal and/or metal alloy layers are thin-film coatings which are substantially transparent to light. As such, rear illumination of these films will result in significant light bleed-through which will result in a poor aesthetic. To overcome this, the present inventors have devised a multi layered solution which includes a primary visually-opaque layer which prevents the transmission of light through the metal, or metal alloy, layer.

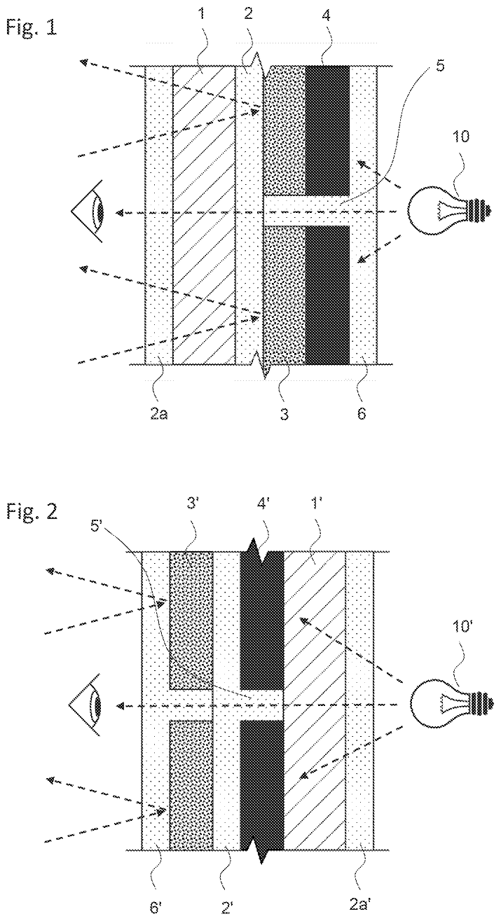

Accordingly, as illustrated in FIGS. 1 to 6, there is provided a radome, which in use has a first (viewing) side and a second (rear) side, the radome comprising a visually-transparent and radio-transmissive substrate 1, 1′ that is provided, on at least the first side (for a first side radome) or the second side (for a second side radome), with a hard coat layer 2, 2′ to provide a hard-coated surface. The radio-transmissive substrate 1, 1′ can also be provided with a protective or second hard coat layer 2a, 2a′ on the opposing surface to protect the radio-transmissive substrate 1,1′ from external elements. The radome is also provided with a radio-transmissive layer 3, 3′ comprising a metal and/or metal alloy which is applied to the hard-coat layer 2, 2′. The application to the hard-coat layer 2, 2′ helps to promote adhesion of the layer 3, 3′ comprising a metal and/or metal alloy to the substrate 1, 1′. As described herein, the layer 3, 3′ comprising a metal and/or a metal alloy may be overlaid with additional layers to form a ‘spectrally controlling layer’ comprising a stack of layers (not shown). Further, the decorative radome comprises a primary visually-opaque layer 4, 4′, the purpose of which is to prevent light transmission across the radome, and in some embodiments through the layer 3, 3′ comprising metal and/or metal alloy. In order to permit selective light transmission across the radome, an area and/or portion 5, 5′ is provided which is void of at least the primary visually-opaque layer 4, 4′, and may also be void of the layer 3,3′. This void portion 5, 5′ provides a path for light transmission across the radome and allows for a visual feature to be provided in the radome, which can be backlit to provide a specific visual image such as a symbol.

The final form of the radome will ultimately have at least a portion of the layer 3, 3′ visible from the viewing side of the radome and will also have a void portion 5, 5′ which can be selectively illuminated and visible (when illuminated) from the viewing side. Further, in some preferred forms, the radome will include visible decorative portions which may be provided by either a secondary visually-opaque layer 7, 7′ or a decorative layer 8, 8′, which will provide a distinct visual features compared to the layer 3, 3′ comprising the metal and/or metal alloy. For example, the radome may include black, or coloured decorative portions provided by the decorative layer 8, 8′ as well as the layer 3, 3′ comprising a metal and/or a metal alloy.

The arrangement of the various layers of the radome relative to the substrate will depend on multiple factors including: the intended in use orientation of the radome (for example if it is a first surface or second surface coated radome), the intended final appearance, and the opacity of the layer 3, 3′.

Various embodiments of the radome of the present invention (whereby the layer 3, 3′ comprising a metal and/or metal alloy is partially transparent) are illustrated in FIGS. 1 to 4. Typically, metal and/or metal alloy layers need to be deposited as thin films to manage the residual stress within the layer and to prevent formation of visual defects such as “pin-holes”, crazing and delamination This results in a semi-transparent layer that permits considerable light bleed-through.

Because of the semi-transparent nature of standard thin film metal/metal alloy layers, they can be difficult to back light and often requires masking. This is problematic when transparent or voided portions are provided as it requires accurate alignment of the multiple layers. Further, it can be difficult to achieve sufficient adherence between a metal/metal alloy layer and the masking layer.

To overcome issues with light bleed-through of the metal/metal alloy layer, the present inventors provide a primary visually-opaque layer 4, 4′ that prevents transmission of light across the radome. In portions where the layer 3, 3′ is to be visible, the primary visually-opaque layer 4, 4′ will be provided on the rear-side of the metal/metal alloy layer 3, 3′ in at least the portions of the radome where it is desirable to prevent light bleed-through.

A simplified second surface embodiment of the layer of metal or metal alloy the present invention is illustrated in FIG. 1. From the viewing (first) side of the radome to the opposing rear (second) side there is provided a secondary or front hard coat layer 2a, which is optional—but is advantageous—and which protects the underlying substrate 1. On the second surface of the substrate 1 there is provided a hard-coat layer 2 which promotes adherence of the layer 3 comprising a metal and/or a metal alloy, and also allows for plasma pre-treatment of the coated substrate. Subsequently, and to prevent light bleeding through the layer 3 comprising a metal and/or a metal alloy, there is a primary visually-opaque layer 4 located on the rear side of the layer 3 comprising a metal and/or a metal alloy. An optional overlaying rear hard coat layer 6 may be including to encapsulate and protect the underlying layers. As can be seen, there is also a portion 5 of the radome which is void of the primary visually-opaque layer 4, thereby permitting light transmission across the radome. In the illustrated embodiments, this void portion 5 is also void of the layer 3 comprising a metal and/or a metal alloy, although because this layer 3 may be semi-transparent it may overlay the void portion 5 if desired.

During production, the deposition of the layers will be from the radio-transmissive substrate. Accordingly, a method for producing the radome of FIG. 1 will include the steps of:
1) providing or forming the radio-transmissive substrate 1,
2) applying a hard coat layer 2 to the second surface of the substrate 1 to provide a hard-coated surface,
3) applying a radio-transmissive layer 3 comprising a metal and/or metal alloy to the hard-coat layer 2, and
4) applying a primary visually opaque layer 4 to the first surface of the substrate 1.

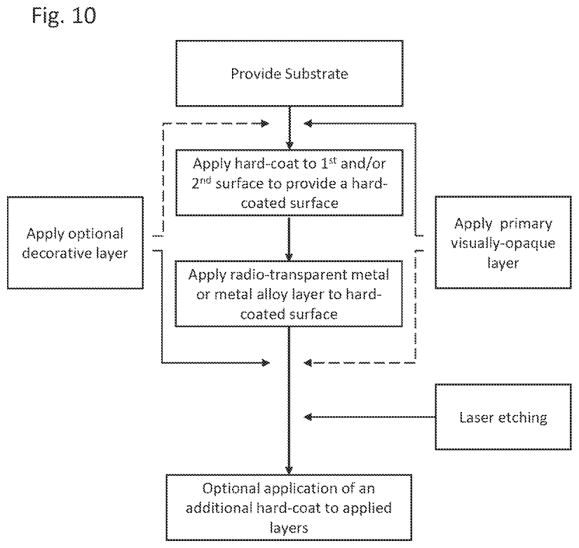

The above method is illustrated in FIG. 10 and may also include the additional steps of applying a hard coat layer 2a to the first surface of the substrate 1 (which may be applied at the same time as the second surface hard coat layer 2) and/or the optional step of applying a rear hard coat layer 6 that overlays the primary visually-opaque layer 4 and the layer 3 comprising a metal and/or metal alloy, thereby protecting the underlying layers.

The portion 5 of the radome which is void of at least the primary visually-opaque layer 4 can be achieved by not applying the primary visually-opaque layer 4 (and optionally the layer 3 comprising the metal and/or metal alloy) to the relevant portion. This may be achieved by means such as masking or selective deposition of the relevant layers. Alternatively, and preferably, areas of the primary visually-opaque layer 4 and optionally the layer 3 comprising a metal and/or a metal alloy, may be removed after deposition, for example by laser etching. Therefore, the method may further include the step of laser etching to remove at least portions of the primary visually-opaque layer 4 and optionally the layer 3 comprising the metal and/or metal alloy to provide a void portion 5.

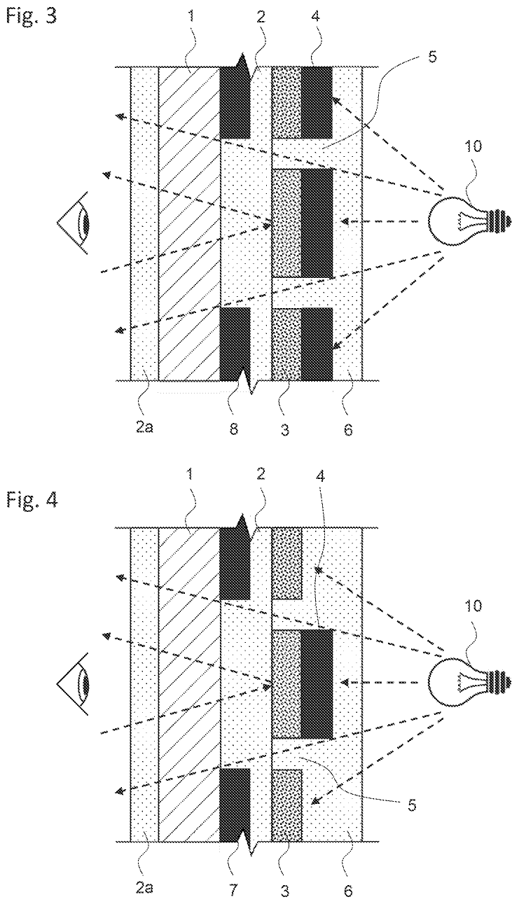

Additional variations of this method may be made including those described below for FIGS. 3 and 4.

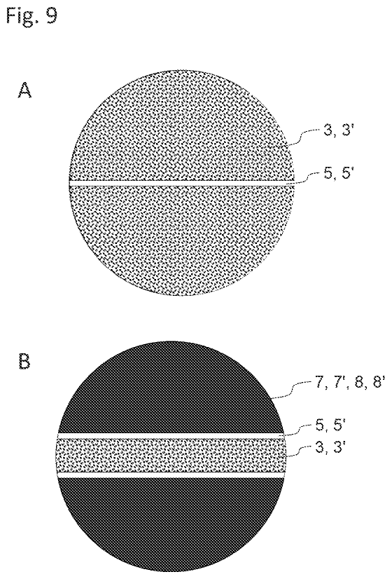

From the viewing side, the radome of FIG. 1 will have a metallic look corresponding to the layer 3 comprising a metal and/or a metal alloy with a void portion 5 allowing rear illumination of a visual feature (see FIG. 9A).

FIG. 2 provides a simplified first surface embodiment of the radome of the present invention. The radome comprises the following layers, in order from the viewing (first) side of the radome to the opposing rear (second) side. An optional overlaying front hard coat layer 6′, which encapsulates and protects the underlying layer 3′ comprising a metal and/or a metal alloy, defines the first surface of the radome of FIG. 2. Underlying this layer 6′ is the layer 3′ comprising a metal and/or a metal alloy. This layer 3′ is located on a hard-coat layer 2′ of the substrate 1′, in the same manner as the radome of FIG. 1. The application of the layer 3′ to the hard coat layer 2′ provides improved adherence. Because the layer 3′ is located on the hard-coat layer 2′, the primary visually opaque layer 4′, which is positioned on the rear side of the layer 3′ comprising a metal and/or a metal alloy, is applied directly to the substrate 1′ and is overlayed with, and encased within, a hard coat which provides the hard-coat layer 2′. Subsequently, the substrate 1′ is provided with a rear hard coat layer 2a′ which is optional, but is preferred and acts to protect the underlying substrate 1′.

From the viewing side, the radome of FIG. 2 will have the same appearance as that in FIG. 1 (see FIG. 9A).

While the arrangement of the layers in the first surface radome of FIG. 2 have been described in order from the viewing side, the deposition of the layers will be from the radio-transmissive substrate 1′, which is positioned at the rear side of the visible coating and/or layer. Accordingly, a method for producing the radome of FIG. 2 will include the steps of:
1) providing or forming the radio-transmissive substrate 1′,
2) applying a primary visually-opaque layer 4′ to the first surface of the substrate 1′,
3) applying a hard coat layer 2′ to the first surface of the substrate 1′ and to the primary visually-opaque (decorative) layer 4′ to provide a hard-coated surface, and
4) applying a radio-transmissive layer 3′ comprising a metal and/or metal alloy to the hard-coated surface.

The alignment of the primary visually-opaque layer 4′ and the layer 3′ comprising a metal and/or metal alloy are such that the layer 3′ comprising a metal and/or metal alloy overlays and sits on the viewing side of the primary visually-opaque layer 4′. This prevents light transmission through the layer 3′ comprising a metal and/or metal alloy.

The above method is illustrated in FIG. 10 and may also include the additional optional step of applying a hard coat layer 2a′ acting as rear hard coat layer to the second surface of the substrate 1′ (which can be applied at the same time as the first surface hard coat layer 2′) and/or the optional step of applying a hard coat layer 6′ that acts as front hard coat layer and overlays the layer 3′ comprising a metal and/or metal alloy, thereby protecting the underlying layer(s).

The portion of the radome 5′ which is void of at least the primary visually-opaque layer 4′ can be achieved in the same manner as described previously for FIG. 1.

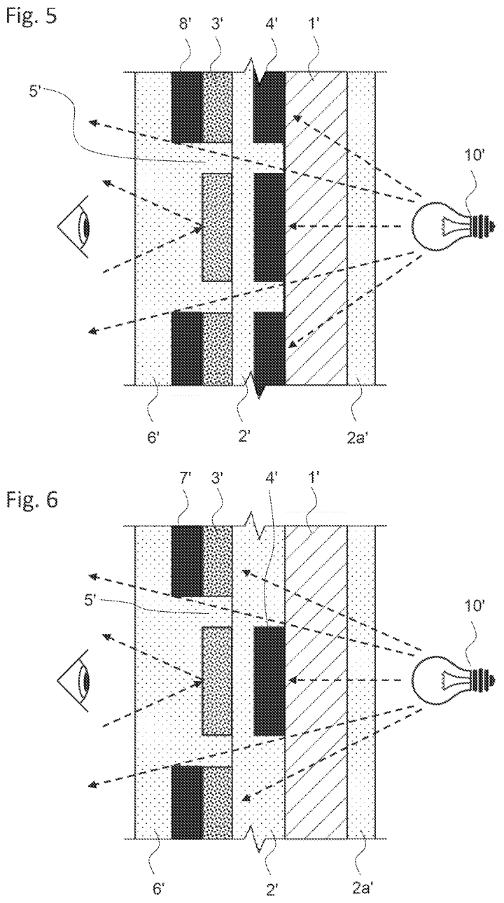

Additional variations of this method may be made including those described below for FIGS. 5 and 6.

As will be noted, the difference in the method for providing the second surface radome of FIG. 1 and the first surface radome of FIG. 2 is the timing of providing the primary visually-opaque layer 4, 4′. To prevent light bleed-through, while still visibly exposing the layer 3, 3′ comprising a metal and/or a metal alloy, the visually-opaque layer 4, 4′ needs to be provided to the rear of the layer 3, 3′ comprising the metal and/or metal alloy. Hence, in the second surface radome of FIG. 1, the primary visually-opaque layer 4 is located on the second (rear) surface of the layer 3 comprising the metal and/or metal alloy. However, in the first surface radome of FIG. 2, the primary visually-opaque layer 4′, is located on the substrate 1′ and is overlayed with, and encapsulated by, a hard coat layer 2′. This provides a hard-coated surface, which improves adhesion of the layer 3′ comprising the metal and/or metal alloy.

A metallic look is desired on the viewing side of the radome. However, to increase the design flexibility of the radome, it is desirable to also include visual features in addition to the metallic look on the viewing side. Therefore, it may be desirable to provide a decorative coating and/or layer that is visible from the front of the radome (see FIG. 9B).

FIGS. 3 and 4 illustrate cross-sections of second surface radomes in accordance with the present invention, which include a decorative layer.

The radome or FIGS. 3 and 4 comprise—from the (front/first) viewing side of the radome to the opposing (rear) side—a front hard coat layer 2a, which is optional (but is advantageous) and which protects the underlying substrate 1. Located on the second surface of the substrate 1, there is a decorative layer 8 (FIG. 3). This decorative layer 8 is visible through the substrate 1 and forms part of the appearance of the radome. The decorative layer 8 may purely be cosmetic or may also prevent transmission of light, in which case it is referred to herein as a secondary visually-opaque layer 7 (see FIG. 4). The substrate 1 and the decorative layer 8, or a secondary visually-opaque layer 7 is coated by, and encapsulated with, a hard coat layer 2 to provide a hard-coated surface, which promotes adherence of the adjacent layer 3 comprising a metal and/or a metal alloy. Subsequently, and to prevent light bleeding through the metal/metal alloys layer, there is a primary visually-opaque layer 4 on the rear side of the layer 3 comprising a metal and/or a metal alloy. Accordingly, the (primary) visually-opaque layer 4 and the decorative layer 8, or a secondary visually-opaque layer 7, are interspaced by the layer 3 comprising the metal and/or metal alloy. An optional overlaying rear hard coat layer 6 may be included which encases and protects the underlying layers. Finally, a void portion 5 allows the transmission of light across the radome.

As mentioned above, a front view of the radome of FIGS. 3 and 4 is provided in FIG. 9B, and illustrates that, from the viewable side of the radome, the decorative layer 8, or the secondary visually opaque layer 7, overlays at least a portion of the layer 3 comprising the metal and/or metal alloy, thereby obstructing the view of this layer.

The distinction between the radome of FIG. 3 and FIG. 4 is that the primary visually-opaque decorative layer 4 is provided to the second (rear) side of the entirety of the layer 3 comprising the metal and/or metal alloy in FIG. 3, but not in FIG. 4. Therefore, the decorative layer 8 in FIG. 3 is not required to function as a layer preventing light transmission. However, in the embodiment of the radome in FIG. 4, only the portion of the layer 3 comprising a metal and/or a metal alloy that is visible from the front of the radome has the primary visually-opaque layer 4 positioned at its rear side. The other portions of the layer comprising a metal and/or metal alloy (which are not to be seen) have a decorative coating and/or layer on the front side which is required to function as a (secondary) visually-opaque layer 7 preventing light transmission across the radome. In this form the decorative coating and/or layer is a secondary visually-opaque layer 7.

The method for providing the radome illustrated in FIGS. 3 and 4 will be the same as that of FIG. 1 with the exception that a decorative layer 8, 7 is applied to the second surface of the substrate 1 and prior to the application of a hard coat layer 2.

FIGS. 5 and 6 illustrate cross sections of first surface radomes in accordance with the present invention, which include an additional decorative layer 8′, or a secondary visually-opaque layer 7′.

The radome or FIGS. 5 and 6 comprise—from the (front/first) viewing side of the radome to the opposing (rear) side—an optional overlaying front hard coat layer 6′ which encapsulates and protects the underlying layers. A secondary visually-opaque layer 7′ acting as a decorative layer and/or coating' or a decorative layer 8′ and a layer 3′ comprising a metal and/or a metal alloy. The later of these layers abuts a hard-coated surface of the substrate 1, in particular the hard coat layer 2′. This hard-coated surface improves adherence of the layer 3′. The primary visually-opaque layer 4′ is positioned on the first surface of the substrate 1′ and is encased in a hard coat layer 2′. Finally, the substrate 1′ has a rear hard coat layer 2a′ on its second surface, which is optional but is preferred and acts to protect the underlying substrate 1′. Finally, a void portion 5′ allows the transmission of light across the radome.

As mentioned above, a front view of the radome of FIGS. 5 and 6 is provided in FIG. 9B.

The distinction between the radome of FIG. 5 and FIG. 6 is the primary visually-opaque decorative layer 4′ is located at the second (rear) side of the entirety of the layer 3′ comprising the metal and/or metal alloy in FIG. 5, but not in FIG. 6. Therefore, the decorative layer 8′ in FIG. 5 is not required to function as a layer preventing light transmission. However, in the embodiment of the radome in FIG. 6, only the portion 3′ of the layer comprising a metal of a metal alloy that is visible from the front of the radome has the primary visually-opaque layer 4′ positioned at its rear side. The other portions of the layer 3′ comprising a metal and/or metal alloy (which are not to be seen) have a decorative coating and/or layer on the front side which is required to function as a visually-opaque layer preventing light transmission across the radome. In this form the decorative coating and/or layer is a secondary visually-opaque layer 7′.

The method for providing the radome illustrated in FIGS. 5 and 6 will be the same as that of FIG. 2 with the exception that a decorative layer 8′, or secondary visually-opaque layer 7′, is applied on the first surface of the layer 3′ comprising a metal and/or metal alloy, and is subsequently encapsulated by the application of a first surface hard coat layer acting as front hard coat layer 6′.

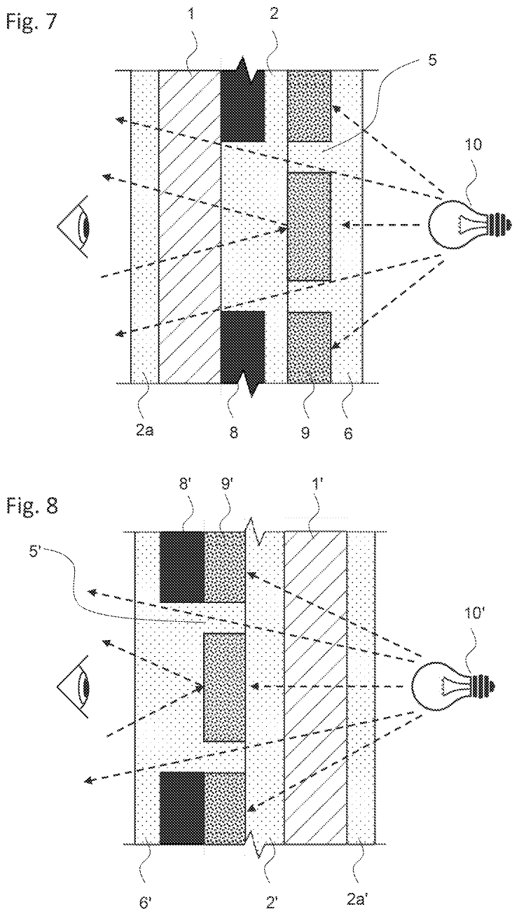

FIGS. 7 and 8 illustrate embodiments of the radome wherein a layer 9, 9′ comprising the metal and/or metal alloy is itself visually opaque (while still being radio transmissive). This may be achieved by providing a sufficiently thick metal and/or metal alloy layer 9, 9′ so as to prevent light bleed-through. Alternatively, stacks of multiple layers (not shown) may be used to form spectrally controlling layer, as described below. These stacks may provide sufficient opacity to prevent light bleeding through the layer 9, 9′ comprising a metal and/or a metal alloy. In this form, this layer 9, 9′ provides both the visually-opaque layer and the layer comprising a metal and/or a metal alloy, which are separate layers in the embodiments of FIGS. 1 to 6. As a result, it is not necessary to provide a rear side visually-opaque layer.

FIG. 7 illustrates a second surface radome including an optional first surface hard coat layer in form of front hard coat layer 2a on the substrate 1. On the rear, second, surface of the substrate 1 there is a decorative layer 8 which functions as a viewable decorative layer but does not need to prevent light bleed through. This decorative layer 8 is encased in a hard coat layer 2. The layer 9 comprising a metal and/or metal alloy is located on the second surface of the hard coated layer 2. Finally, the rear most layer is a hard coat layer forming a rear hard coat layer 6, which is optional, but which protects the underlying layers.

FIG. 8 illustrates a first surface radome including a hard coat layer acting a front hard coat layer 6′, which overlays a decorative layer 8′, which functions as viewable decorative coating and/or layer, but which does not need to prevent light bleed through. There is also provided a visually-opaque layer 9′ comprising a metal and/or metal alloy which directly abuts the first surface of a hard coat layer 2′ which is located on the first surface of the substrate 1′. Finally, on the second side of the substrate 1′ is a second surface hard coat layer forming a rear hard coat layer 2a′, which is optional, but which is preferred and acts to protect the underlying substrate 1′.

A front view of the radomes of FIGS. 7 and 8 is provided in FIG. 9B.

### Substrate

The substrate used in the present invention can be any suitable substrate that is radio-transparent, and preferably visually-transparent. In some preferred embodiments, the substrate is a polymer, preferably a plastic.

Preferably the plastic substrate is a synthetic polymer, such as: Acrylonitrile Ethylene Styrene (AES), Acrylonitrile butadiene styrene (ABS), acrylonitrile styrene acrylate (ASA), Polyamide (PA), polybutylene terephthalate (PBT), Polycarbonate (PC), Polyethylene (PE), Polyethylene Teraphthalate (PET), Poly(methyl methacrylate) (PMMA), Polyoxymethylene (POM), Polypropylene (PP), Polyurethane (PU), PolyVinyl-Chloride (PVC), high-flow AES, acrylonitrile-(ethylene-propylene-diene)-styrene (AEPDS), blends of thermoplastics, or PC-ABS blended thermoplastic. In some embodiments, the substrate is Polycarbonate. Polycarbonate has desirable visual transparency and radio transmissibility as well as physical resilience suitable for use in environments such as vehicles.

Ideally the substrate is formed in its desired shape prior to deposition of any layers. In some embodiments, the substrate is provided formed in the desired shape. In other embodiments, the method of the invention includes forming, moulding or otherwise shaping the substrate. For example, the substrate can be thermo-moulded, injection moulded or injection compression moulded, prior to application of the subsequent layers.

### Primary Visually-Opaque Layer and Decorative Layer

The visually-opaque layer(s) acts to substantially reduce the light transmission across the radome and therefore prevent light bleed through when a light source is provided on the rear side of the radome.

In some embodiments, the visually opaque layer(s) 4, 4′, 7, 7′, 9, 9′ prevent transmission of at least 90%, at least 91%, at least 92%, at least 93%, at least 94%, at least 95%, at least 96%, at least 97%, at least 98%, at least 99%, at least 99.5%, or at least 99.9% of light in the visible spectrum across the radome.

In some embodiments, the visually opaque layer(s) 4, 4′, 7, 7′ in combination with the layer 3, 3′ comprising a metal and/or a metal alloy prevent transmission of at least 90%, at least 91%, at least 92%, at least 93%, at least 94%, at least 95%, at least 96%, at least 97%, at least 98%, at least 99%, at least 99.5%, or at least 99.9% of light in the visible spectrum across the radome.

The visually-opaque layer(s) 4, 4′, 7, 7′ or decorative layer 8, 8′ can be any suitable layer which provides the necessary opacity. In some embodiments, the visually-opaque layer(s) or decorative layer is an ink, dye, oil, wax, polymer, lubricant or other suitable liquid, or a film.

In some embodiments, the visually-opaque layer 4, 4′,7, 7′ or decorative layer 8, 8′ is an ink. The ink can be deposited by any suitable method. In some embodiments, the visually-opaque layer 4, 4′, 7, 7′ or decorative layer 8, 8′ is printed. Printing methods may include dye diffusion thermal transfer, wax thermal transfer, indirect dye diffusion thermal transfer, screen printing, inkjet printing or a gravure printing process such as pad printing. In some embodiments, the visually-opaque layer 4, 4′, 7, 7′ or decorative layer 8, 8′ is applied by pad printing.

Suitable methods are known in the art for printing on radio-transmissive substrates 1, 1′. For example, inks such as Norilit™ U, NoriPURm, Tampo-Jet GMI (all by Proell, Inc.), TPR 980 (Marabu Printing Inks), TP313-65HD and LAB-N (both by Coates Screen Inks) can be pad printed onto a three dimensional substrate, such as the radio transmissive substrate 1, 1′. Other suitable inks and printing methods are known in the art and can be used in the invention disclosed herein.

In some embodiments, the visually-opaque layer 4, 4′, 7, 7′ or decorative layer 8, 8′ is provided by in mould decoration (IMD), film insert moulding or in mould lamination (IML).

### Layer Comprising a Metal or a Metal Alloy

The layer 3, 3′, 9, 9′ comprising a metal and/or a metal alloy is preferably a reflective layer and/or has a metallic appearance, and includes any suitable metal and/or metal alloy that provides the desired reflectivity or appearance while being radio-transmissive. In some embodiments, the metal which forms the layer 3, 3′, 9, 9′ includes transition metals. In some embodiments, the metal in the layer 3, 3′, 9, 9′ is Indium, Aluminium, Germanium or Tin. In a preferred embodiment, the metal is Indium. The layer 3, 3′, 9, 9′ is a continuous layer.

In some forms, the layer comprising a metal or a metal alloy is not a single layer but includes multiple layers which are stacked to form a desired appearance. Such stacks form a layer having a reflective or metallic appearance and may be referred to as a “spectrally controlling layer”. Typically, these layers create the visual appearance of a traditional metal layer, such a chromium, without causing significant attenuation of radio-waves.

The separate layers in the spectrally controlling layer act to tune the visual appearance of the radome to achieve a desired visual effect and typically involve multiple layers of absorbent (or reflective) layers and transparent layers. The advantage of such a system is that different materials can be used to tune the visual appearance of the layer as well as the residual stress of the layer. Moreover, the stress of the layers may be controlled to manage the differential stress at the interface between the layers. This can prevent visual defects forming within the layer, prevent delamination of the layer from the substrate or adjacent layers, and control adhesion of the layer to its adjacent layers.

The importance of residual stress, the use of interfacing layers in controlling residual stress, and determination of residual stress parameters are described in WO/2021/018422 A1, WO/2011/075796 A1 and U.S. Pat. No. 9,176,256 B2, each of which is hereby incorporated by reference in their entirety and for all purposes.

Examples of metal (and metalloids) which can be used to form the spectrally controlling layer include, Indium, Tin, Aluminium, Germanium, Silicon and Silicon Dioxide. These metals may be provided alone, or may also be provided as alloys, such as AlGe (Aluminium and Germanium).

In some embodiments, the layer comprises silicon. In some embodiments, the layer comprises silicon dioxide. In a preferred embodiment, the layer comprising a metal or a metal alloy includes a layer of Indium and a layer of Silicon Dioxide.

Examples of stacks of layers include In/Si/In/SiO₂, In/AlGe/In/SiO₂ or In/Ge/In/SiO₂.

To promote appropriate adhesion of the layer 3, 3′, 9, 9′ comprising a metal and/or metal alloy to the substrate 1, 1′, the substrate 1, 1′ is provided with a hard coat layer 2, 2′ which provides a hard-coated surface. The layer 3, 3′, 9, 9′ comprising a metal or a metal alloy is then directly deposited onto hard-coated surface 2. This allows for significantly improved adhesion of the layer 3, 3′, 9, 9′ comprising the metal and/or metal alloy. To facilitate this, any layer (such as the visually opaque layers 4, 4′, 7, 7′ or the decorative layer 8, 8′) which is located between the substrate 1, 1′ and the layer 3, 3′, 9, 9′ comprising the metal and/or metal alloy is overlayed by a hard coating and/or hard coat layer which encapsulates the interspacing layer and provides the required hard-coated surface.

The layer 3, 3′, 9, 9′ comprising a metal and/or a metal alloy is required to be radio-transmissive. Preferably, it only minimally attenuates radar signals in the range of 76 to 81 GHz or 76 to 77 GHz. Means to measure attenuation are known in the art and include the Rohde-Schwartz (R&S®) QAR System. The influence of metal and/or metal alloy coatings on polycarbonate are disclosed in WO2021/018422 A1 and disclosed in the Examples below.

The layer 3, 3′, 9, 9′ comprising the metal and/or metal alloy is provided as a thin-coating layer. In some embodiments, the average thickness of the layer 3, 3′, 9, 9′ comprising a metal and/or metal alloy is 20 to 190 nm thick, or 40 to 170 nm thick, or 60 to 150 nm thick. Such thin-coatings can be provided by multiple methods in the art. However, preferably, the layer 3, 3′, 9, 9′ is deposited by Physical Vapour Deposition (PVD). Suitable PVD methods include magnetron sputtering and evaporation, which may be resistive thermal evaporation or electron-beam evaporation. In some embodiments, the layer 3, 3′, 9, 9′ comprising the metal and/or metal alloy is deposited by magnetron sputtering.

Hard Coatings and/or Hard Coat Layers

Hard coats and/or hard coat layers are positioned as various locations throughout the radome with the location determining the intended function of the hard-coat layer. Due to the different roles of the hard coatings and/or hard coat layers, the material which forms them may be different. For example, the hard coat layer 2, 2′ which forms the hard-coated surface provides a surface for promoting adherence of the layer 3, 3′, 9, 9′ comprising a metal and/or a metal alloy. UV irradiation is produced during plasma pre-treatment prior to the PVD coating which may result in degradation of the substrate 1, 1′ and compromise adhesion with subsequently applied layers. Therefore, the hard-coated surface and/or hard coat layer 2, 2′ also acts to protect the underlying substrate 1, 1′ from UV light exposure during PVD which helps promote adhesion of the layer 3, 3′, 9, 9′ comprising a metal and/or metal alloy.

However, the optional second hard coat layer on the substrate acting as front hard coat 2a and rear hard coat 2a′, respectively, and optional final hard coat acting as rear hard coat layer 6 and front hard coat layer 6′, respectively, act to protect the underlying layers and/or substrate, and will therefore be selected to have suitable properties for this function. The inclusion of the second hard coat layer 2a, 2a′ is preferable as is acts to protect the underlying substrate in both the first and second surface embodiments of the invention.

However, in some embodiments, all of the hard coats will be formed of the same material. In some embodiments, the hard-coat layer 2, 2′ and the optional hard coat layer 2a, 2a′ will be formed of the same material and will be applied to the substrate 1, 1′ at the same time, for example by dip coating (see below).

The application of a hard coat layer 2, 2′ (and optionally 2a, 2a′) may also improve the visual appearance of the radome. Hard coat layers 2, 2′ 2a, 2a′ may fill any small (μm deep) imperfections, scratches or undulations in the substrate 1, 1′ and underlying layers. This advantage can uniquely be achieved in the present invention as it does not need overmolding, like two-piece radomes. Typically, the application of such a hard coating at the interface between the two pieces of an overmolded radome will decrease adhesion between the pieces and is therefore not typically used.

A coating and/or hard coat layer that is said to be a “hard-coating” is a coating and/or layer that is harder or more resilient than the radio-transmissive substrate 1, 1′, and/or protects the radio transmissive substrate 1, 1′ from UV degradation. Such hard coatings and/or hard coat layers are ones that reduces damage due to impacts, UV exposure or scratching. Typically, hard coatings and/or hard coat layers protect the underlying layers and/or substrates and may improve the radome's resistance to abrasion.

Abrasion resistance can be measured through standard tests such as ASTM F735 “Standard Test Method for Abrasion Resistance of Transparent Plastics and Coatings Using the Oscillating Sand Method”, ASTM D4060 “Standard Test Method for Abrasion Resistance of Organic Coatings”, by the Taber Abrader, or by using the well-known Steel wool Test.

The hard coating and/or hard coat layer may include a primer layer that bonds well to the substrate 1, 1′ and forms a preferable surface for subsequent layers. The primer layer may be provided by any suitable material and may for example be an organic resin such as an acrylic polymer, a copolymer of acrylic monomer and methacryloxysilane, or a copolymer of a methacrylic monomer and an acrylic monomer having a benzotriazole group or benzophenone group. These organic resins may be used alone or in combinations of two or more.

The hard-coat layer(s) are preferably formed from one or more materials selected from the group consisting of an organo-silicon, an acrylic, a urethane, a melamine or an amorphous SiOₓC_{y}H_{z}.

Most preferably, the hard-coat layer(s) is/are an organo-silicon layer, due to its su-perior abrasion resistance and compatibility with physical vapour deposited films. For example, a hard-coating layer comprising an organo-silicon polymer can be formed of a compound se-lected from the following compounds: trialkoxysilanes or triacyloxysilanes such as: methyltri-methoxysilane, methyltriethoxysilane, methyltrimethoxyethoxysilane, methyltriacetoxysilane, methyltripropoxysilane, methyltributoxysilane, ethyltrimethoxysilane, ethyltriethoxysilane, vi-nyltrimethoxysilane, vinyltriethoxysilane, vinyltracetoxysilane, vinyltrimethoxyethoxysilane, phenyltrimethoxysilane, phenyltriethoxysilane, phenyltriacetoxysilane, gamma-chloro-propyltrimethoxysilane, gamma-chloropropyltriethoxysilane, gamma-chloro-propyltripropoxysilane, 3,3,3-trifluoropropyltrimethoxysilane gamma-glycidoxypropyltri-methoxysilane, gamma-glycidoxypropyltriethoxysilane, gamma-(beta-glycidoxyeth-oxy) propyltrimethoxysilane, beta-(26,4-epoxycyclohexyl)ethyltrimethoxysilane, beta-(26,4-epoxycyclohexyl)ethyltriethoxysilane, gamma-methacryloxypropyltrimethyoxysilane, gamma-aminopropyltri-methoxysilane, gamma-aminopropyltriethoxysilane, gamma-meraptopropyltri-methoxysilane, gamma-mercaptopropyltriethoxysilane, N-beta (aminoethyl)-gamma-ami-nopropyltrimethoxysilane, beta-cyanoethyltriethoxysilane and the like; as well as dial-koxysilanes or diacyloxysilanes such as dimethyldimethoxysilane, phenylmethyldimethox-ysilane, dimethyldiethoxysilane, phenylmethyldiethoxysilane, gamma-glycidoxypropylmethyl-dimethoxysilane, gamma-glycidoxypropylmethyldiethoxysilane, gamma-glycidoxypro-pylphenyldimethoxysilane, gamma-glycidoxypropylphenyldiethoxysilane, gamma-chloro-propylmethyldimethoxysilane, gamma-chloropropylmethyldiethoxysilane, dimethyldiace-toxysilane, gamma-methacryloxypropylmethyldimethoxysilane, gamma-metacryloxypropyl-methyldiethoxysilane, gamma-mercaptopropylmethyldimethoxysilane, gamma-mercapto-propylmethyldiethoxysilane, gamma-aminopropylmethyldimethoxysilane, gamma-ami-nopropylmethyldiethoxysilane, methylvinyldimethoxysilane, methylvinyldiethoxysilane and the like.

Commercially available hard coats include Momentive hard coats e.g. UVHC3000, UVHC5000, PHC587B/C, PHCXH100P and AS4700F. Each of these coatings and/or layers has differing abrasion resistance, weatherability performance and deposition parameters. Accordingly, a skilled person will be able to select the appropriate coating and/or layer for the intended purpose of the plastic article. In some preferred embodiments, the hard coating and/or layer is Momentive SilFORT PHC587B or AS4700F.

The abrasion resistant layers may be coated onto the plastic substrate 1, 1′ by dip coating in liquid followed by solvent evaporation, or by plasma enhanced chemical vapour deposition (PECVD) via a suitable monomer such as Hexamethyldisiloxane (HMDSO). Alternative deposition techniques such as flow coating and spray coating are also suitable. To improve the abrasion resistance of the hard-coating(s) and/or layer(s), subsequent coatings and/or layers of the abrasion resistant layer may be added, preferably within a 48-hour period so as to avoid aging and contamination of the earlier coatings and/or layers.

In some embodiments, the hard-coat layer(s) on the substrate 2, 2′, 2a, 2a′ and the optional final hard coat 6, 6′ is/are coated onto the substrate by any one of: dip coating in liquid followed by solvent evaporation, or by plasma enhanced chemical vapour deposition (PECVD) via a suitable monomer, flow coating or spray coating. In some embodiments, the final hard coat 6 is applied by PECVD, preferably the PECVD coating is HMDSO.

In some embodiments, the substrate 1, 1′ is dip coated with a hard coat and/or hard coat layer such that the first and second surface are coated.

Further coatings and/or layers, in addition to those discussed above, may be applied to the external surfaces of the radome to modify the surface properties of the radome. For example, a cap layer may also be provided by materials having characteristics, including: hydrophobic, hydrophilic, lipophobic, lipophilic and oleophobic or combinations thereof.

### Void Portion

As illustrated in FIGS. 1 to 9 the radome of the present invention includes a portion 5, 5′ which is void of at least the primary visually-opaque layer 4, 4′. This provides an area where light (indicated by the dashed arrows) can traverse the radome. This is particularly desirable when the radome is illuminated from the rear with a light source 10, 10′. As indicated in FIGS. 1 to 9 light (indicated by dashed lines) from the rear side of the radome is generally prevented from passing through the radome by the opaque layers (i.e. the primary visually-opaque layers 4, 4′, 9, 9′ or secondary visually-opaque layers 7, 7′). However, in areas void of these layers, the light can pass through the radome. This allows for the design of additional visual features and symbols into the radome which may be used for aesthetic and design purposes.

In preferred embodiments, the radome has portions 5, 5′ which are void of both the opaque layers 4, 4′, 7, 7′, or the decorative layer 8, 8′ and the layer 3, 3′, 9, 9′ comprising the metal and/or metal alloy. Obviously, in embodiments such as those in FIGS. 7 and 8 where the layer 9, 9′ comprising a metal and/or a metal alloy is also visually opaque, then the void portion 5, 5′ only needs to be void of the single layer, although it may be desirable to also be void of the decorative layer 8, 8′.

While not illustrated, it is envisaged that the void portion 5, 5′ may not be void of the layer 3, 3′, 9, 9′ comprising a metal and/or a metal alloy. Because thin films typically allow some transmission of light, light passing through the void portion 5, 5′ may also pass through an overlying portion of the layer 3, 3′, 9, 9′ comprising a metal and/or metal alloy. Such an option may be chosen when it is desirable to hide the visual feature to be backlit.

The void portion 5, 5′ can be provided in any suitable means. However, in a preferred form, the void portion 5, 5′ is provided by laser etching away the visually-opaque layers 4, 4′, 9, 9′ and/or 7, 7′ and optionally the layer 3, 3′ comprising the metal and/or metal alloy or the decorative layer 8, 8′. Accordingly, the method of the invention includes laser etching the radome to form the void portion 5, 5′ (see FIGS. 10 and 11). This method can provide accurate removal of the relevant layers and allows for clear and sharp visual features.

The void portion 5, 5′ can be formed by other means such as using masks to prevent deposition of the opaque layers 4, 4′, 7, 7′ 9, 9′ and optionally the layer 3, 3′ comprising the metal and/or metal alloy or the decorative layer 8, 8′. Alternatively, the void portion 5, 5′ can be formed by selective deposition of the relevant layers. For example, by selective pad printing, selective in mould decoration, or selective film deposition.

### Radome Attenuation and Technical Characteristics

The radome of the invention should not substantially attenuate electromagnetic frequencies of 10 MHz to 3000 GHz. Specifically, in some embodiments, the radome has a radar attenuation less than 2 dB one-way (4 dB two-way) across a signal path, or preferably 1 dB one-way (2 dB two-way) across a signal path. Further, the layer 3, 3′ comprising a metal and/or a metal alloy should have a sheet resistivity greater than 106 ohms per square (Ω/□) in situ. The surface resistivity of the layer 3, 3′ 9, 9′ comprising a metal and/or metal alloy can be determined using a four-point method, using a four-point probes in accordance with JIS K7194.

To minimise refraction of the radar signal, as it passes through the radome of the invention, the front and rear face should be parallel or substantially parallel. Further, the interior of the radome should have no voids, air bubbles or significant changes in material density such as water ingress, and the metal and/or metal alloy layer alone or together with the additional layers should be of a uniform thickness.

Radio-wave attenuation and reflectance will be determined by the requirements of the user, the application, the frequency used, and the equipment being used. In some embodiments, there will be a minimum of 10 dB reflection. In some embodiments there will be a maximum of 2 dB one-way (4 dB two-way) attenuation at a specific operating frequency between 76 and 81 GHz. In some embodiments, there will be less than 2 dB one-way attenuation at 24 GHz, 77 GHz or 79 GHz. In some embodiments, there will be a maximum of 1 dB one-way (2 dB two-way) attenuation at a specific operating frequency between 76 and 81 GHz. In some embodiments, there will be less than 1 dB one-way attenuation at 24 GHz, 77 GHz or 79 GHz.

The substrate and layers thereon attenuate the radio-wave signal as it traverses the radome. A portion of this attenuation is a product of the reflection of the radio-wave signal from the first surface or second surface of the substrate 1, 1′ as the radio-waves emanating from the transmitter traverse the radome. Consequently, the attenuation, as a result of reflection, is determined by the thickness of the substrate 1, 1′ (and layers thereon) and the wavelength of the traversing radio-waves. The wavelength of the radio-wave as it passes through the substrate varies with the dielectric real permittivity of the substrate 1, 1′. Therefore, the substrate thickness providing minimum attenuation is determined by the equation

$$m \frac{λ i}{2} ,$$

where m is an integer and λi is the wavelength of the radio-wave transmitted from a radio-wave transmitter as it passes through the substrate 1. Consequently, in some embodiments, the thickness of the radome substrate 1 is a multiple of

$$\frac{λ i}{2} .$$

### Examples

### Substrate Attenuation

### Substrate Thickness

To assess the influence of the substrate on attenuation of radio-wave at the 76-77 GHz band, bare (uncoated) polycarbonate samples at approximately 2, 2.3, 3, 4.5 and 6 mm (actual thickness 2.0. 2.33, 2.92, 4.42 and 5.84 mm) were obtained and assessed at a 10-degree tilt angle in a Rohde-Schwartz (R&S®) QAR System as per the manufacturer's instructions. The data was analysed, and a line of best fit was then applied to the generated results. The assumed dielectric constant of polycarbonate at 77 GHz is 2.8.

Different dielectric substrates have different permittivity, which results in variations of the wavelength of the radio-wave across the substrate. Polycarbonate has a relative permittivity (εr) of 2.8 at 77 GHZ, and therefore the calculated wavelength through the substrate is 2.328 mm.

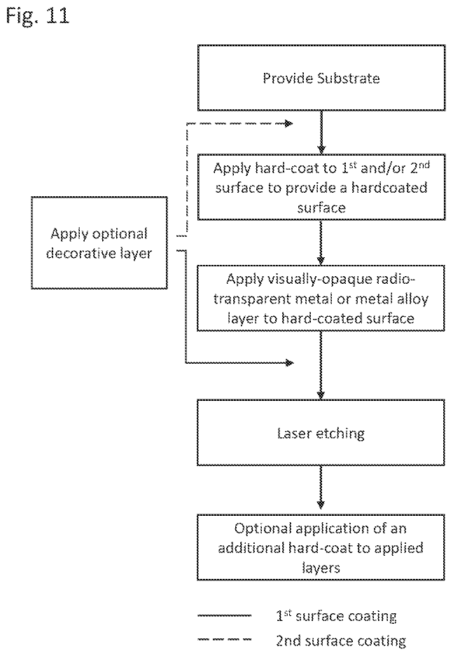

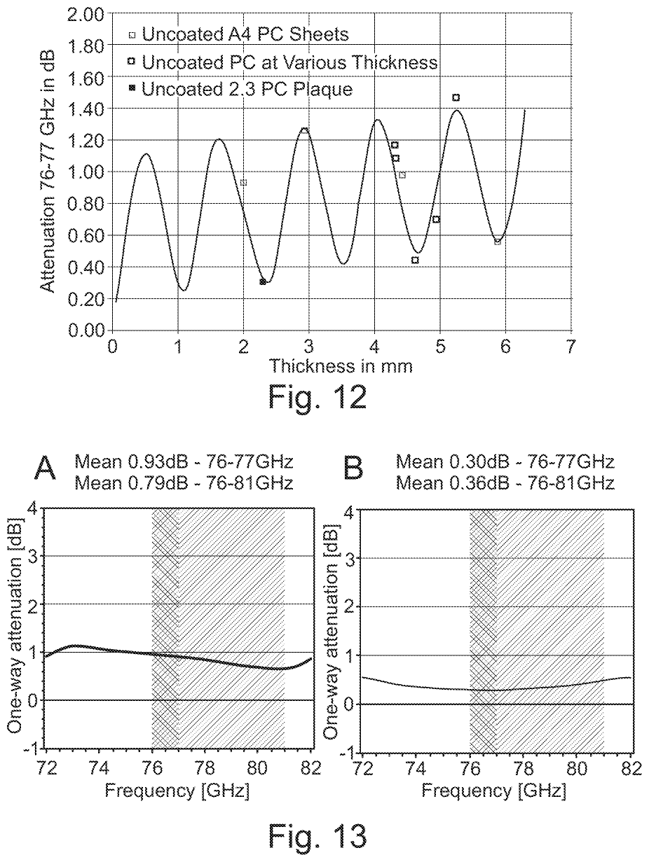

As can be seen in FIG. 12, the attenuation followed an inclined sine curve with attenuation cyclically being at a minimum with substrate thickness that were an integer multiple of half wave length (i.e. 0.5, 1, 1.5, 2, 2.5 etc. times the wavelength of the radio-wave through the substrate), with maximum attenuation being a quarter wave length offset from the minimum (i.e. 0.75, 1.25, 1.75 etc. times the wavelength of the radio-wave through the substrate). Further, the average attenuation across the sine curve increased as the thickness of the sheet increased.

In view of other design requirements for radome use on a vehicle, in some embodiments the optimal thickness is 2.3 mm, which provided minimal attenuation and appropriate robustness, stiffness and weight for use as an automotive body part.

### Attenuation of 77 GHz Vs 79 GHz Radio-Waves

To measure the attenuation at the common radio-wave frequencies used in automotive radar systems, 2 mm (FIG. 13A) and 2.3 mm (FIG. 13B) polycarbonate substrates were assessed across the 76-81 GHz frequencies using the R&S® QAR System as per the manufacturer's instructions.

As can be seen in FIG. 13A, the mean attenuation across the 76-77 GHz frequency was approximately 117% of the mean attenuation across the 76-81 GHz frequency when the polycarbonate substrate was 2 mm. By comparison, and as shown in FIG. 13B, the mean attenuation across the 76-77 GHz frequency was approximately 83% of the mean attenuation across the 76-81 GHz frequency when the polycarbonate substrate was 2.3 mm. As such, the percent variation between the 2 mm and 2.3 mm substrates was 17% when the mean attenuation across the 76-77 GHz frequency was compared to the mean attenuation across the 76-81 GHz frequency, albeit in opposing directions.

However, the difference in the real attenuation was only 0.06 dB when the substrate was 2.3 mm compared to 0.14 dB when the substrate was 2 mm. Therefore, 2.3 mm appears to be the most suitable choice for use with radar systems that use both the 77 GHz and 79 GHz band.

### Methods for Preparing a Coated Substrate

The following examples provide methods by which decorative radomes, in accordance with the present invention, may be prepared.

### Substrate Preparation

Polycarbonate substrates can be injection moulded and stored in a suitable manner to avoid contamination of the surface to be coated. The prepared or formed substrate is then blown off thoroughly with ionised compressed air to remove any particulate that has settled on the surface and to remove static, prior to loading into a pad printer.

### Pad Printing

The substrate is then printed on the second surface with Coates TP313-65HD ink which is then flashed off for 1 minute and cured at 80° C. for 60 minutes.

### Dipcoating—Primer

Once cooled after print curing, the printed substrate is dipped in Momentive SHP470FT primer and removed at 1.5 mm/s. It is then flashed off for 20 minutes and cured at 125° C. for 40 minutes.

### Dipcoating—Hardcoat

Once cooled after primer curing, the printed and primed substrate is dipped in Momentive AS4700F and removed at 12 mm/s, and is subsequently flashed off for 20 minutes and cured at 127° C. for 71 minutes.

### Decorative Coating

Once cooled after hardcoat curing, the printed, primed and hardcoated substrate is loaded into a PVD coating drum, exposing only the second surface predetermined for pre-treatment and coating. It is blown off again with ionised compressed air just before entering the vacuum coating chamber.

A decorative coating and/or layer is deposited on the second surface in accordance with the following parameters:

TABLE 1
Decorative layer coating parameters

| | Examples 1 & 3 - Indium/SiO2 coating | | | Example 2 - Indium/SiO2/HMDSO | | | |
|---|---|---|---|---|---|---|---|
| | Pre- | Layer 1 | Layer 2 | Pre- | Layer 1 | Layer 2 | Layer 3 |
| Parameter | Treatment | (sputtering) | (sputtering) | Treatment | (sputtering) | (sputtering) | (PECVD) |
| Glow discharge | 3 | | | 3 | | | 5 |
| electrodes (Stainless | | | | | | | |
| steel) power (kW) | | | | | | | |
| Indium target power | | 17.5 | | | 17.5 | | |
| (kW) | | | | | | | |
| Dual rotatable | | | 20 | | | 20 | |
| silicon target | | | | | | | |
| power (kW) | | | | | | | |
| Total Gas flow | 800 Ar | 260 Ar | 100 Ar | 800 Ar | 260 Ar | 100 Ar | 210 HMDSO |
| (sccm) | 100 O2 | | 200 O2 | 100 O2 | | 200 O2 | |
| RPM | 6 | 24 | 24 | 6 | 24 | 24 | 20 |
| Number of rounds | 12 | 6 | 20 | 12 | 6 | 20 | 8 |
| Base Pressure | 8e−5 | 1e−5 | 3e−5 | 8e−5 | 1e−5 | 3e−5 | 8e−2 |
| (mbar) | | | | | | | |
| Run Pressure (mbar) | 1e−2 | 2e−3 | 1.6e−3 | 1e−2 | 2e−3 | 1.6e−3 | 6e−2 |

Substrates comprising hard coatings and metal and metalloid layers were prepared in accordance with the preceding methods and provide the following parameters.

TABLE 2
Physical Properties of Coatings

| | Examples 1 & 3 - | | | Example 2 - | | | |
|---|---|---|---|---|---|---|---|
| | Indium/SiO2 coating | | | Indium/SiO2/HMDSO | | | |
| | Pre- | Layer 1 | Layer 2 | Pre- | Layer 1 | Layer 2 | Layer 3 |
| Parameter | Treatment | (sputtering) | (sputtering) | Treatment | (sputtering) | (sputtering) | (PECVD) |
| Resultant Thickness | 0 | 25 | 45 | 0 | 25 | 45 | 8 |
| (nm) | | | | | | | |

| | | |
|---|---|---|
| Residual film stress | −27 | −85.8 |
| displacement (um) | | |

| | |
|---|---|
| Reflected L*, a*, b* | L* 81 |
| from first surface | a* −0.24 |
| (CIEL*a*b*, illumi- | b* 2.24 |
| nant A, 2° observer) | |

### Pad Printing—Decorative Layer

The coated substrate is then printed again on the second surface with Coates LAB-N 341705 ink which is flashed off for 1 minute then cured at 130° C. for 30 minutes.

### Laser Etching

The decorative coated and printed lens is then laser ablated with a G8 Sei Laser to remove the decorative coating and/or layer and printing to provide a void region in the Radome for light transmission.

### Protective Hardcoating—Example 3 Only

The decorative coated, printed and lasered substrate is cleaned thoroughly with a lint free cloth doused with IsoPropyl alcohol, followed by a dry lint free cloth to buff the surface clean. It is then blown off with ionised compressed air and loaded to a spray coating fixture that exposes the rear surface only and protects the front surface from overspray. The sample is then sprayed with 9-16 μm of Momentive PHC587B in an automated spray coater. It is then flashed off for 15 minutes and cured at 130° C. for 71 minutes.

### Mechanical Testing

Radomes prepared in accordance with the above method, but absent the printed layers, were assess for robustness using a series of durability tests (with the specific intent of assessing their suitability for use in automotive purposes).

The tests performed and the outcomes are summarised in Table 3 below.

TABLE 3
Durability testing of coated samples

| | | Result | | |
|---|---|---|---|---|
| | | Example | Example | Example |
| Test | Method | 1 | 2 | 3 |
| Cross hatch | ISO 2409 using a single-blade cutting tool and | PASS | PASS | PASS |
| adhesion | 3M Scotch 8981 tape. Adhesion rating ≤ 1. | | | |
| Water | Immerse a sample for 320 h in water kept at | FAIL | PASS | PASS |
| immersion | 40° C.. | | | |
| Short term | Expose sample to 110° C. for 7 hours. | PASS | PASS | PASS |
| heat | | | | |
| Thermal shock | 200x Cycles −40° C. to 85° C., 1 hr/cycle. | PASS | PASS | PASS |
| Salt spray | Salt Spray for 480 hours as per ASTM B 117. | FAIL | PASS | PASS |
| Russian mud | Expose sample to CaCl3 for 336 hours | FAIL | PASS | PASS |
| test | | | | |
| Condensate | Expose sample to 40° C./100% RH 240 hours. | FAIL | PASS | PASS |
| test | | | | |

All methods described herein can be performed in any suitable order unless indicated otherwise herein or clearly contradicted by context. The use of any and all examples, or exemplary language (e.g., “such as”) provided herein, is intended merely to better illuminate the example embodiments and does not intrinsically pose a limitation on the scope of the claimed invention. However, such embodiments may be the subject of a claimed limitation, or may be considered as an additional feature in the event that it is included in a claim. No language in the specification should be construed as indicating any non-claimed element as essential.

The description provided herein is in relation to several embodiments which may share common characteristics and features. It is to be understood that one or more features of one embodiment may be combinable with one or more features of the other embodiments. In addition, a single feature or combination of features of the embodiments may constitute additional embodiments.

The subject headings used herein are included only for the ease of reference of the reader and should not be used to limit the subject matter found throughout the disclosure or the claims. The subject headings should not be used in construing the scope of the claims or the claim limitations.

Those skilled in the art will appreciate that the invention described herein is susceptible to variations and modifications other than those specifically described. It is to be understood that the invention includes all such variations and modifications. The invention also includes all of the steps, features and/or functions referred to, or indicated in this specification, individually or collectively, and any and all combinations of any two or more of the steps or features.

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

Also, it is to be noted that, as used herein, the singular forms “a”, “an” and “the” include plural aspects unless the context already dictates otherwise.

Future patent applications may be filed on the basis of or claiming priority from the present application. It is to be understood that the following claims are provided by way of example only, and are not intended to limit the scope of what may be claimed in any such future applications. Also, features may be added to or omitted from the claims at a later date so as to further define or re-define the invention or inventions.

In particular the features disclosed in above specification, the claims and the drawings can be essential to the invention in its various embodiments both individually and in any combination.

### REFERENCE SIGN LIST

1, 1′ Substrate
2, 2′ Hard-coat layer
2a Front hard-coat layer
2a′ Rear hard coat layer
3, 3′ Layer comprising a metal and/or a metal alloy.
4, 4′ Primary visually-opaque layer.
5, 5′ Void portion
6 Rear hard coat layer
6′ Front hard coat layer
7, 7′ Secondary visually-opaque layer
8, 8′ Decorative layer
9,9′ Visually-opaque layer
10, 10′ Light source

1. A radome, having a first side and a second side, the radome comprising:
a radio-transmissive and visually-transparent substrate which has on at least the first or second side a hard coat layer to provide a hard-coated surface;
a radio-transmissive layer comprising a metal and/or metal alloy applied to the hard-coated surface; and
a primary visually-opaque layer,
wherein a portion of the radome is void of the primary visually-opaque layer.

2. A radome according to claim 1, wherein the primary visually-opaque layer is located on the first side of the radome.

3. A radome according to claim 1, wherein the primary visually-opaque layer is located on the second side of the radome.

4. A radome, having a first side and a second side, the radome comprising:
a radio-transmissive substrate which has on at least a first side a primary visually-opaque layer;
a hard-coat layer covering at least a portion the primary visually opaque layer to provide a hard-coated surface; and
a radio-transmissive layer comprising a metal and/or metal alloy applied to the hard-coated surface,
wherein a portion of the radome is void of the primary visually-opaque layer.

5. A radome, having a first side and a second side, comprising:
a radio-transmissive substrate which has on a second side a hard-coat to provide a hard-coated surface;
a radio-transmissive layer comprising a metal and/or metal alloy applied to the hard-coated surface; and
a primary-visually-opaque layer located on the second side of the layer comprising a metal and/or metal alloy;
wherein a portion of the radome is void of the primary visually-opaque layer.

6. The radome according to claim 1, wherein the portion void of the primary visually-opaque layer is also void of the layer comprising a metal and/or metal alloy.

7. The radome according to claim 1, wherein the radio-transmissive substrate is a polymer.

8. The radome according to claim 7, wherein the polymer is a plastic or a polycarbonate.

9. (canceled)

10. The radome according to claim 1, further comprising a decorative layer.

11. The radome according to claim 10, wherein the decorative layer is a secondary visually-opaque layer.

12. The radome according to claim 10, wherein the decorative layer can be viewed through the substrate.

13. The radome according to claim 10, wherein one of the primary visually-opaque layer or the decorative layer, is located directly on the substrate.

14. The radome according to claim 10, wherein the primary visually opaque layer or the decorative layer is an ink, dye, oil, wax, lubricant or a film.

15. The radome according to claim 10, wherein the primary visually-opaque layer and the decorative layer are interspaced by the layer comprising a metal and/or a metal alloy.

16. The radome according to claim 10, wherein the decorative layer overlaps with at least a portion of the layer comprising a metal and/or metal alloy.

17. The radome according to claim 1, wherein the primary visually-opaque layer overlaps with at least a portion of the layer comprising a metal and/or metal alloy.

18. The radome according to claim 1, wherein the layer comprising a metal and/or metal alloy comprises indium or comprises indium and a layer of silicon dioxide.

19. (canceled)

20. The radome according to claim 1, wherein the substrate has a hard coat layer on both the first and second surface.

21. The radome according to claim 20, wherein the hard coat layer is selected from one or more of: an organo-silicon, an acrylic, a urethane, melamine, or an amorphous SiOxCyHz.

22. The radome according to claim 1, further comprising an adhesion promoting layer.

23. The radome according to claim 22, wherein the adhesion promoting layer promotes adhesion of a final hard coat layer to provide a hard-coated surface, a front hard coat layer and/or a rear hard coat layer, with an underlying layer.

24. The radome according to claim 1, wherein the radome includes a final hard-coat layer, in particular a hard coat layer to provide a hard-coated surface, a front hard coat layer and/or a rear hard coat layer, covering underlying layers.

25. An assembly comprising the radome according to claim 1, and a radio-wave transmitter and/or receiver.

26. An assembly according to claim 25, further comprising a light and/or a light source for illuminating the void portion of the radome.

27. A vehicle comprising a radome according to claim 1.

28. A method of producing a radome, comprising the steps of:
providing a radio-transmissive substrate;
applying a hard coat layer to at least a first or second surface to provide a hard-coated surface;
applying a radio-transmissive layer comprising a metal and/or metal alloy to the hard-coated surface;
applying a primary visually-opaque layer; and
providing a portion of the radome which is void of the primary visually-opaque layer.

29. The method of claim 28, wherein the primary visually-opaque layer is applied prior to the application of the hard coat.

30. The method of claim 28, wherein the portion of the radome which is void of the primary visually-opaque layer is provided by laser etching.

31. The method of claim 28, wherein the primary visually-opaque layer is provided on the first side of the radome.

32. The method of claim 28, wherein the primary visually-opaque layer is provided on the substrate.

33. The method according to claim 28, wherein the radio-transmissive substrate is a polymer, a plastic, or a ploycarbonate.

34. (canceled)

35. (canceled)

36. The method according to claim 28, wherein providing the radio-transmissive substrate comprises molding the substrate.

37. The method according to claim 36, wherein molding the substrate is thermo-molding or is injection molding or is injection compression molding.

38. The method according to claim 28, wherein the layer comprising a metal and/or metal alloy is applied by physical vapor deposition and/or comprises indium or indium and a layer of silicon dioxide.

39. (canceled)

40. (canceled)

41. The method according to claim 28, wherein the layer comprising a metal and/or metal alloy and the primary visually-opaque layer are applied such that at least a portion of the two layers overlap.

42. The method according to claim 28, including the additional step of applying a decorative layer.

43. The method according to claim 42, wherein the decorative layer comprises, in particular is, a secondary visually-opaque layer.

44. The method according to claim 42, wherein the decorative layer is applied directly to the substrate.

45. The method according to claim 28, wherein the primary visually-opaque layer is applied directly to the substrate.

46. The method according to claim 44, wherein both the layer applied directly to the substrate and the substrate are coated with a hard-coat layer to provide a hard coated surface.

47. The method according to claim 28, wherein the primary visually opaque layer or the decorative layer is applied by pad printing.

48. The method according to claim 28, further comprising the step of applying an adhesion promoting layer.

49. The method according to claim 48, wherein the adhesion promoting layer promotes adhesion between a final hard coat layer to provide a hard-coated surface, a front hard coat layer and/or a rear hard coat layer and an underlying layer.

50. The method according to claim 28, comprising the additional step of providing a final hard coat layer to provide a hard-coated surface, a front hard coat layer and/or a rear hard coat layer, to protect the layers on the substrate.

51. A radome, having a first side and a second side, the radome comprising:
a radio-transmissive and visually-transparent substrate which has on at least the first or second side a hard coat layer to provide a hard-coated surface;
a radio-transmissive layer comprising a continuous metal layer and/or a continuous metal alloy layer applied to the hard-coated surface; and
a primary visually-opaque layer applied to the radio-transmissive layer,
wherein a portion of the radome is void of the primary visually-opaque layer and the portion void of the primary visually-opaque layer is also void of the layer comprising a metal and/or metal alloy.

52. A radome, having a first side and a second side, the radome comprising:
a radio-transmissive substrate which has on at least a first side a primary visually-opaque layer;
a hard-coat layer covering at least a portion the primary visually opaque layer to provide a hard-coated surface; and
a radio-transmissive layer comprising a continuous metal layer and/or a continuous metal alloy layer applied to the hard-coated surface,
wherein a portion of the radome is void of the primary visually-opaque layer and the portion void of the primary visually-opaque layer is also void of the layer comprising a metal and/or metal alloy.

53. A method of producing a radome, comprising:
providing a radio-transmissive substrate;
applying a hard coat layer to at least a first or second surface to provide a hard-coated surface;
applying a radio-transmissive layer comprising a continuous metal layer and/or a continuous metal alloy layer to the hard-coated surface;
applying a primary visually-opaque layer to the radio-transmissive layer; and
providing a portion of the radome which is void of the primary visually-opaque layer, wherein the portion void of the primary visually-opaque layer is also void of the layer comprising a metal and/or metal alloy.
